(19) United States
(12) Patent Application Publication
(10) Pub. No.: US 2012/0100331 A1
(43) Pub. Date: Apr. 26, 2012

(54) SELF-CLINGING MAT FOR EATING ASSISTANCE

(76) Inventors: Cynthia L. Bowen, Washington, NC (US); Walter Lee Bowen, Washington, NC (US)

(21) Appl. No.: 12/909,365

(22) Filed: Oct. 21, 2010

(51) Int. Cl. B32B 3/30; B32B 3/02

(52) U.S. Cl. 428/81; 428/156

(57) ABSTRACT

An eating assistance mat includes a substantially planar sheet of a pliable grippy material with a perimeter and first and second oppositely facing surfaces with a minimum thickness therebetween and defined by the perimeter. The first surface faces a first direction and substantially covers the entirety of the sheet within the perimeter. The second surface faces a second direction opposite the first direction and substantially covering the entirety of the sheet within the perimeter. The first surface be substantially smooth, while the second surface includes a plurality of protrusions thereon that extend outward generally in the first direction. The protrusions may be arranged in a regular array, and may be round when viewed normal to the second surface. The sheet may be sized and shaped to fit, while laying flat, within a rectangle of 16 inches by 11 inches.

### BACKGROUND

Placemats have been in common use for some time. Conventional placemats provide a number of advantages, including providing a means to prevent dishes from sliding on tabletops and other surfaces (e.g., countertops). However, conventional eating mats or placemats are commonly formed from woven fabrics that tend to absorb or otherwise take in spilled liquids and therefore are problematic to clean. Other conventional eating mats or placemats are formed of pliable plastic materials, with smooth upper and lower surfaces. While such smooth sided mats may be easier to clean, they may allow food placed directly on the mat to slide away from a challenged eater, such as a child or disabled adults. Thus, there remains a need for alternative approaches to the design of eating mats.

### SUMMARY

The present invention provides an eating assistance mat that may be used in conjunction with a conventional highchair having a tray, or on a countertop, or on a conventional tabletop. The eating assistance mat may be particularly advantageous for use with small children who are still developing the motor skills to eat independently without spilling their food.

In one embodiment, the eating assistance mat includes a substantially planar sheet of a pliable grippy material. The sheet has a perimeter. The sheet also has first and second oppositely facing surfaces with a minimum thickness therebetween and defined by the perimeter. The first surface faces a first direction and substantially covers the entirety of the sheet within the perimeter. The second surface faces a second direction opposite the first direction and substantially covers the entirety of the sheet within the perimeter. The first surface may be substantially smooth, while the second surface includes a plurality of protrusions thereon that extend outward generally in the first direction. The perimeter may have a forward edge, a rearward edge, a left edge, and a right edge; with at least one of the forward and rearward edges, or sometimes both, curving in a plane parallel to the second surface. In some embodiments, the forward edge is convexly curved and the rearward edge is concavely curved. The left and right edges may be convexly curved. The protrusions may be arranged in a regular array, and may be round when viewed normal to the second surface. The sheet may be sized and shaped to fit, while laying flat, within a rectangle of 16 inches by 11 inches.

The various aspects of the invention may be used alone or in combination, as is desired.

### BRIEF DESCRIPTION OF THE DRAWINGS

FIG. 1 shows a highchair and a mat according to one embodiment of the present invention.

FIG. 2 shows a top view of the mat of FIG. 1.

FIG. 3 shows a side view of the mat of FIG. 1.

FIG. 4 shows a bottom view of the mat of FIG. 1.

FIG. 5 shows a partial cross-sectional view of the mat of FIG. 1.

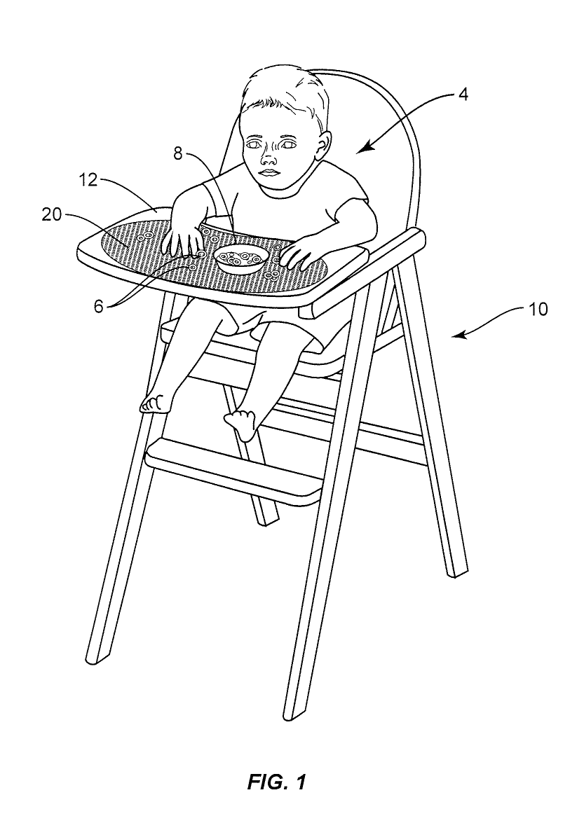

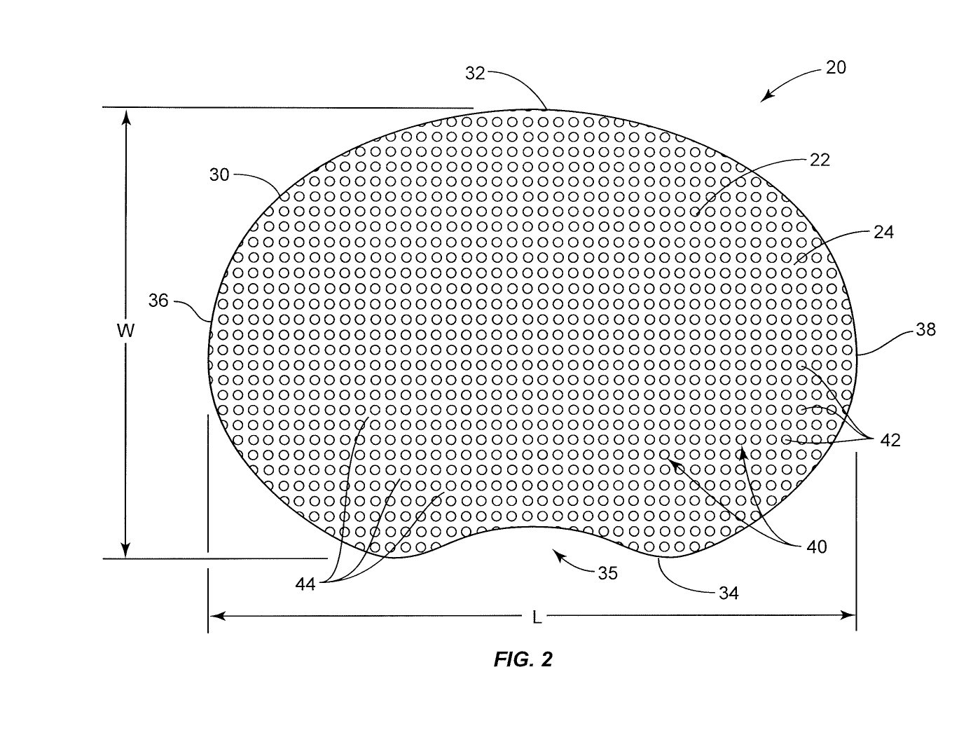

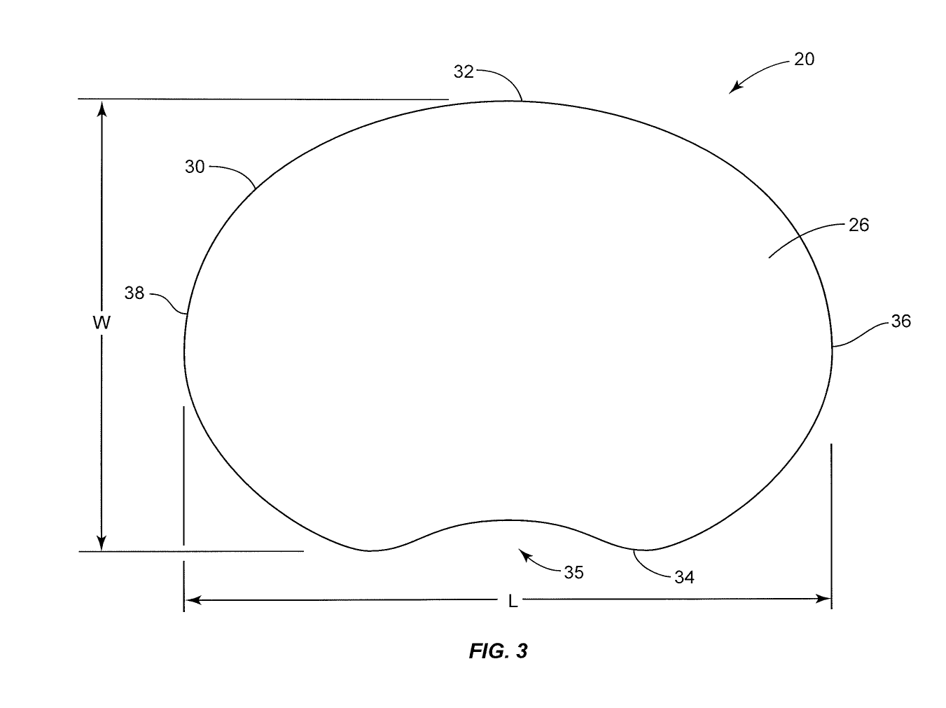

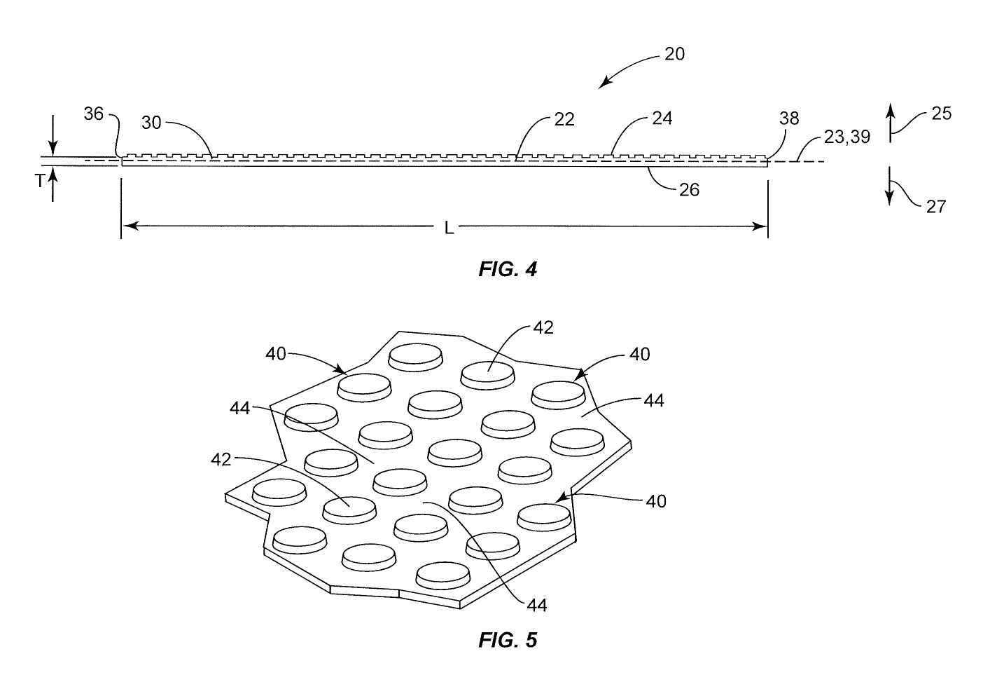

### DETAILED DESCRIPTION

The present invention relates eating mat 20s, sometimes referred to as placemat 20s, and particularly an eating assistance mat 20 that allows for greater ease of picking up food placed directly on the mat 20.

In one embodiment, an eating assistance mat 20 is provided. The eating assistance mat 20 is intended to be used in conjunction with a conventional highchair 10 having a tray 12, or on a countertop, or on a conventional tabletop. The eating assistance mat 20 may be particularly advantageous for use with small children, such as child 4, who are still developing the motor skills to eat independently without spilling their food 6.

The eating assistance mat 20 takes the form of a substantially planar sheet 22 having a perimeter 30. The sheet 22 includes an upper surface 24 facing in an upward direction 25 and a lower surface 26 facing in downward direction 27. The upper surface 24 and lower surface 26 are separated by a minimum thickness T. The lower surface 26 is substantially smooth, advantageously with a mirror-like finish. The upper surface 24 includes a plurality of protrusions 40, sometimes called knobs. The protrusions 40 are advantageously arranged in a regular array, although other arrangements are possible, such as an irregular array. The protrusions 40 extend upward and advantageously have a flat upper extent or tip 42. In some embodiments, the protrusions 40 have a round shape when viewed from above; in other embodiments, the protrusions 40 may have other geometric shapes, such as square, triangular, star, etc., which may be regular or irregular. The protrusion arrangement advantageously substantially cover the entirety of the upper surface 24.

The perimeter 30 conceptually includes a forward edge 32, a rearward edge 34, a left edge 36, and a right edge 38. In the illustrated embodiment, all four of these edges 32,34,36,38 are curved, with the forward edge 32, the left edge 36, and the right edge 38 being convexly curved with blended boundaries. In the illustrated embodiment, the rearward edge 34 is convexly curved so as to mimic the shape of a conventional highchair 10 tray 12. Thus, the rearward edge 34 defines a recess 35. All four edges 32,34,36,38 in the illustrated embodiment curve in a plane 39 that is parallel to the plane 23 of the sheet 22 when the sheet 22 is laying flat. It should be understood that the perimeter 30 may take other shapes, including ones where one or more of the edges 32,34,36,38 are straight.

The sheet 22 is advantageously sized and shaped to conform to the shape of the corresponding highchair tray 12 so that the eating assistance mat 20 may lay flat in the tray 12. Thus, the eating assistance mat 20 advantageously has a length L approximately sixteen inches or less and a width W of approximately eleven inches or less. Stated another way, the sheet 22 is sized and shaped to fit, while laying flat, within a rectangle of sixteen inches by eleven inches. This size provides ample space for dishes, but remains suitable for use with highchair trays 12.

The sheet 22 is formed of a pliable grippy material. Examples of suitable materials include thermoplastic rubber (TPR), silicone, [Inventors, please list additional materials]. These materials display a grippy characteristic in that they tend to slightly stick to a smooth tabletop without the use of adhesives or the like. The material should be dishwasher safe, and plainly should be non-toxic. Advantageously, the material avoids the use of latex, polyvinylchloride (PVC), and phthalates. The minimum thickness T between the upper surface 24 and the lower surface 26 (in the gaps 42 between protrusions 40) should be approximately ______.

The sheet 22 may be used initially as a simple placemat 20 upon which dishes 8 are placed. In such use, the sheet 22 is advantageously oriented “upside down” so that the smooth side (lower surface 26) facing in the upward direction 23. This arrangement provides for the simplest cleanup should spills occur, because there are not protrusions 40 and their associated gaps 42 into which spilled food 6 may be trapped. When desired, the sheet 22 may be turned over to provide a better surface from which food 6 may be picked up when placed directly on the mat 20. That is, the sheet 22 may be placed “rightside up” so that the upper surface 24 with its protrusions 40 is facing in the upward direction 23. The presence of the spaced apart protrusions 40 provides additional small “walls” against which solid food 6 may be manually moved so as to be more easily picked up. For example, O-shaped cereal may be placed directly on the mat 20, which was previously placed in the tray 12 of a highchair 10. A child 4 in the highchair 10 then may push an O-shaped cereal bit along the mat 20 so that it encounters a gap 42 between protrusions 40. This encourages the O-shaped cereal bit to tilt slightly so that it may be abutted against one or more the protrusions 40 to be easily picked-up even by a child that is still developing the motor skills to eat independently. Similarly, a disabled adult will find it easier to pick up food 6 placed on upper surface 24, whether the mat 20 is placed in a tray 12, or simply placed on a suitable flat surface such as a tabletop or countertop.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. An eating assistance mat, comprising:
a substantially planar sheet of a pliable grippy material;
the sheet having a perimeter;
the sheet having a first and second oppositely facing surfaces with a minimum thickness therebetween and defined by the perimeter;
the first surface facing a first direction and substantially covering the entirety of the sheet within the perimeter;
the second surface facing a second direction opposite the first direction and substantially covering the entirety of the sheet within the perimeter;
the first surface be substantially smooth;
the second surface comprising a plurality of protrusions thereon that extend outward generally in the first direction;

2. The eating assistance mat of claim 1 wherein the perimeter comprises a forward edge, a rearward edge, a left edge, and a right edge; wherein at least one of the forward and rearward edges curve in a plane parallel to the second surface.

3. The eating assistance mat of claim 2 wherein both the forward and rearward edges curve in the plane parallel to the second surface.

4. The eating assistance mat of claim 3 wherein the forward edge is convexly curved and the rearward edge is concavely curved.

5. The eating assistance mat of claim 2 wherein the left and right edges are convexly curved.

6. The eating assistance mat of claim 1 wherein the protrusions are arranged in a regular array.

7. The eating assistance mat of claim 1 wherein the protrusions are round when viewed normal to the second surface.

8. The eating assistance mat of claim 1 wherein the protrusions have flat upper tips.

9. The eating assistance mat of claim 1 wherein the sheet is sized and shaped to fit, while laying flat, within a rectangle of 16 inches by 11 inches.

10. The eating assistance mat of claim 1 wherein the pliable grippy material is thermoplastic rubber.
